(19) United States
(12) Patent Application Publication
(10) Pub. No.: US 2011/0014418 A2
(43) Pub. Date: Jan. 20, 2011

(54) CARRIER PLATE FOR A PUNCHING TOOL

(75) Inventor: Peter MARBACH, Heilbronn (DE)

Correspondence Address: ROTHWELL, FIGG, ERNST & MANBECK, P.C., 1425 K STREET, N.W., SUITE 800, WASHINGTON, DC, 20005, UNITED STATES, 2027836040, 2027836031, PTO-PAT-Email@rfem.com

(73) Assignee: Karl Marbach GmbH & Co. KG, Heilbronn (DE)

(21) Appl. No.: 12/642,403

(22) Filed: Dec. 18, 2009

(30) Foreign Application Priority Data
Dec. 19, 2008 (DE) 202008016884.8
Nov. 18, 2009 (EP) 09176274.0

(51) Int. Cl. B32B 5/12; B32B 21/14; B32B 15/10; B32B 17/02; B32B 7/02; B32B 21/02; B32B 21/04

(52) U.S. Cl. 428/106; 428/535; 428/464; 428/221; 428/215; 428/485

(57) ABSTRACT

A carrier plate (1) for a punching tool includes two external layers (3,4), between which a middle layer (2) is arranged, wherein the middle layer (2) is formed by a core made of compacted fibers and the external layers (3, 4) are formed by wood veneer.

### FIELD OF THE INVENTION

The invention relates to a carrier plate for a punching tool having two external layers, between which a middle layer is arranged.

### DESCRIPTION OF THE BACKGROUND ART

DE 203 20 658 U1 discloses a carrier plate for a punching tool having at least two layers. The middle layer of this carrier plate preferably consists of a foamed plastic, especially epoxy resin. The external layer consists of a compound material made of artificial resin and glass fabric or made of metal.

A disadvantage of the carrier plate disclosed in DE 203 20 658 U1 is the use of non-recyclable epoxy resins in the middle layer of the carrier plate. In addition, the materials used are relatively cost-intensive to manufacture.

Furthermore, it is known to use so-called composite plates as carrier plates in the construction of punch dies. These consist, for example, of a compound made of sheet metal/wood/sheet metal, sheet metal/plastics/sheet metal or sheet metal/sisal, resin/sheet metal. A carrier plate made of a compound made of metal/plastics/metal is known from DE 24 044 06 C3. Herein preferably an epoxy resin is used in the middle layer; the external layer preferably consists of a dimensionally stable metal, such as copper, brass, aluminum or magnesium.

A disadvantage of such carrier plates is that the recycling of epoxy resins is problematic. Another disadvantage is a relatively high weight, which results from the use of metals for the upper and lower external layers. Among other things, this makes it more difficult to handle the carrier plate when installing it in the punch die apparatus.

Other known carrier plates for the construction of punch dies consist of multiplex plates made of new veneer. These consist of at least 5 equally thick veneer layers which are in most cases made of beech, birch, spruce or maple wood and have thicknesses of 0.5 to 2.5 mm. The plates are pressed together using urea glue, and they are glued together crosswise. Use is also made of multiplex plates made of a mixture of various types of wood. These carrier plates have a long dynamic lifetime.

In the case of such carrier plates, a laser is used to form slots for receiving cutting and creasing rules. In order to achieve an even formation of the slots with a constant laser power, it is required that the veneer plates do not contain any knobs or the like. However, such defectfree veneer plates are cost-intensive.

### SUMMARY OF THE INVENTION

The object underlying the invention is to provide a carrier plate for a punching tool which can be manufactured at comparably low costs, but has a long dynamic lifetime and in which accurately fitting recesses can be formed by means of a laser.

This object is achieved by a carrier plate for a punching tool having two external layers, between which a middle layer is arranged, wherein said middle layer is formed by a core made of compacted wood fibers and said external layers are formed by wood veneer.

Each external layer can be formed by one wood veneer ply, but preferably by two crosswise glued wood veneer plies, preferably made of birch veneer. The plies are glued together by means of a glue and using pressure. It is advantageous to bond the external layers to the middle layer by means of laserable glue, preferably urea glue.

Preferably the middle layer consists of an MDF (medium-density fiberboard) wood fiber core, an LFD (low-density fiberboard) wood fiber core or an HDF (high-density fiberboard) wood fiber core made of wood fibers from conifers and/or deciduous trees, said fibers being manufactured in the form of plates by moistening them with synthetic binding agents and waxes and using a hot-pressing process. Advantageously, binding agents are used which are environmentally acceptable as well as biodegradable.

In accordance with one embodiment, an MDF core of the “H” type is used as the MDF core. An MDF core of the “H” type has a low length and thickness swelling in case water-proof glue is used.

Preferably, the wood veneers have a thickness of 0.1 to 2.5 mm, and the middle layer has a thickness of 2.4 to 21.8 mm, wherein the thickness of the middle layer constitutes 30 to 99% of the overall thickness of the carrier plate.

Preferably, between each two plies of wood veneer there is a reinforcement made of plastics, metal or glass fiber fabric having a thickness of 0.05 to 0.5 mm, said reinforcement having a grid-like structure with a mesh width of 0.05 to 5 mm. Advantageously, a wood-glue compatible sizing agent having a thickness of maximally 0.001 mm (1 μm) is applied onto this reinforcement, and subsequently the two plies of wood veneer are glued together crosswise.

Preferably, finally a grinding process is used to face-grind the carrier plate, and the carrier plate is calibrated to a standard dimension at a thickness tolerance of ±0.3 mm.

Preferably, the surface of the carrier plate is coated for protection purposes with water-soluble acrylic enamel (UV-hardened) or with a melamine film.

Thus the carrier plate according to the invention can be manufactured at relatively little expense, and yet it has all the required properties. Among those are a high dimensional stability even after a large number of punching operations, a low absorption of humidity, a good cutting rule mountability, a high rigidity and compression load capacity as well as a good plane-parallel position at a low thickness tolerance.

Moreover, renewable starting materials can be used, leading to a positive environmental balance through the use of secondary materials. Depending on the thickness of the carrier plate according to the invention a percentage of 30 to 99% of secondary materials can be achieved.

### BRIEF DESCRIPTION OF THE DRAWINGS

Hereinafter exemplary embodiments of the invention are explained by means of the accompanying drawings, wherein

FIG. 1 is a side view of a first embodiment of a carrier plate, and

FIG. 2 is a side view of a second embodiment of a carrier plate.

### DETAILED DESCRIPTION OF THE INVENTION

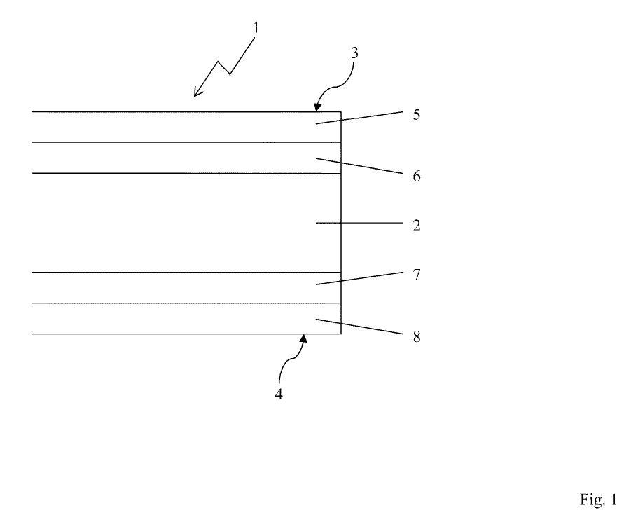

The carrier plate 1 shown in FIG. 1 has three layers: a middle layer 2 consisting of a plate-shaped MDF wood fiber core and two external layers 3, 4, each of which is formed by two crosswise glued plies 5, 6 and 7,8, respectively, made of birch veneer which is as defect-free and even as possible. The middle layer 2 and the external layers 3, 4 have been glued together by means of a urea glue using pressure and heat, wherein the external layers 3, 4 are glued together cross-wise.

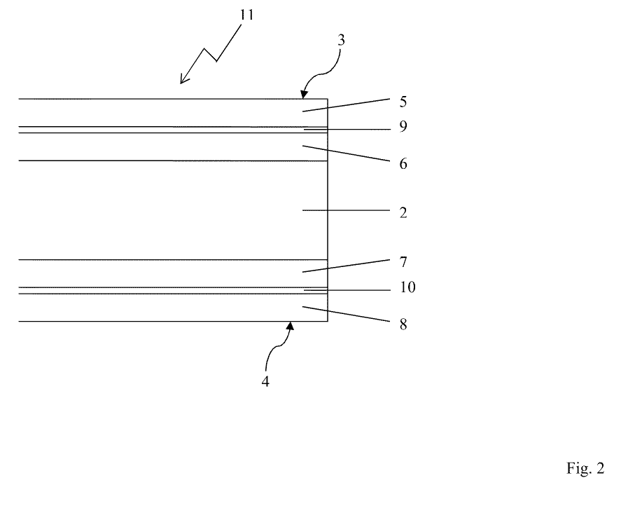

The carrier plate 11 shown in FIG. 2 differs from the carrier plate 1 shown in FIG. 1 in that between the two plies of birch veneer 5, 6 and 7, 8, respectively, there is a reinforcement 9, made of glass fiber fabric having a mesh width of 1.7 mm and a thickness of 0.3 mm, which reinforcement has been treated with a chromium or silane sizing agent having a thickness of 1 μm. Thereinafter the two plies of birch veneer 5, 6 and 7, 8, respectively, are glued together crosswise with the reinforcement arranged therebetween. In the case of this exemplary embodiment, the reinforcement has the function of minimizing expansion forces.

In the case of both described carrier plates 1 and 11, respectively, 85 to 90% of the middle layer 2 consist of wood from conifers (spruce, fir, pine), and 10 to 15% consist of deciduous trees (beech, oak, maple). The whole carrier plate 1 and 11, respectively, has a thickness of 18.2 mm, wherein the birch veneer plies each have a thickness of 1.4 mm and the middle layer 2 has a thickness of 12.6 mm (2*1.4 mm birch veneer at the top, 12.6 mm middle layer, 2*1.4 mm birch veneer at the bottom).

The thickness tolerance of the middle layer 2 amounts to ±0.2 mm and the curvature should not exceed 1.5 mm/m. The MDF middle layer 2 used herein has an average density of 770 kg/m³, wherein the density tolerance amounts to ±30 kg/m³. The transverse tensile strength amounts to ≧0.75 N/mm², and the flexural strength amounts to ≧35 N/mm².

For protection purposes, the surface is coated with water-soluble acrylic enamel (UV-hardened).

Due to the preferred use of birch veneer in the external layers 3, 4 and of the MDF core as the middle layer 2 of the carrier plate 1, the carrier plates 1 and 11, respectively, have good laser cutability. The preferred use of a special urea glue (BFU-20) leads to a laserable gluing of the carrier plates 1 and 11, respectively. As far as safety at work is concerned, the MAK (maximum allowable concentration) values are not exceeded during the thermal decomposition of the carrier plate according to the invention 1 and 11, respectively. The cutting speed of the carrier plates according to the invention 1 and 11, respectively, corresponds to standard values. The dimensional accuracy of the punch die can be maintained for specified sizes of 0 to 1,000 mm at ±0.6 mm and for specified sizes of >1,000 mm at ±0.7 mm. The homogeneity in the overall plate structure, which is important for laser cutability, can be maintained through the use of an MDF core in the middle layer 2.

1. A carrier plate for a punching tool having two external layers, between which a middle layer is arranged, wherein said middle layer is formed by a core made of compacted wood fibers and said external layers are formed by wood veneer.

2. The carrier plate as claimed in claim 1, wherein said external layers each comprise two plies made of wood veneer.

3. The carrier plate as claimed in claim 2, wherein a reinforcement is arranged between said two plies of wood veneer.

4. The carrier plate as claimed in claim 3, wherein said reinforcement has a grid-like structure.

5. The carrier plate as claimed in claim 3, wherein said reinforcement is made of plastics, metal or glass fiber fabric.

6. The carrier plate as claimed in claim 3, wherein a wood-glue compatible sizing agent is applied onto said reinforcement.

7. The carrier plate as claimed in claims 2, wherein said two plies of wood veneer are glued together crosswise.

8. The carrier plate as claimed in claim 1, wherein said external layers are bonded to said middle layer by means of a laserable adhesive, preferably urea glue.

9. The carrier plate as claimed in claim 1, wherein a thickness of said middle layer constitutes 30 to 99% of an overall thickness of said carrier plate.

10. The carrier plate as claimed in claim 2, wherein said plies of wood veneer each have a thickness of 0.1 to 2.5 mm, preferably 1.4 mm.

11. The carrier plate as claimed in claim 1, wherein said core made of compacted wood fibers is formed by one of an MDF core, an LDF core and an HDF core.

12. The carrier plate as claimed in claim 11, wherein said one of an MDF core, an LDF core and an HDF core consists of fibers from at least one of conifers and deciduous trees and is manufactured in a form of a plate by moistening it with synthetic binding agents and waxes and using a hot-pressing process.

13. The carrier plate as claimed in claim 12, wherein said binding agents are environmentally acceptable and biodegradable.
